(19) United States
(12) Patent Application Publication
(10) Pub. No.: US 2009/0299783 A1
(43) Pub. Date: Dec. 3, 2009

(54) Method and system for defense capability in trading in a complex environment

(75) Inventors: Robert James BARTON, Hampshire (GB); Andrew John DAW, Surrey (GB); Caroline Mary GOWING, Hampshire (GB); Owen David SUDLOW, Finton (GB); Fleur Martinique ETCHELLS, Hampshire (GB); Samuel Davis SIMPSON, Hampshire (GB)

Correspondence Address: BUCHANAN, INGERSOLL & ROONEY PC, POST OFFICE BOX 1404, ALEXANDRIA, VA, 22313-1404, US

(73) Assignee: BAE Systems PLC, London (GB)

(21) Appl. No.: 12/385,651

(22) Filed: Apr. 15, 2009

Related U.S. Application Data
(60) Provisional application No. 61/071,157, filed on Apr. 15, 2008.

(51) Int. Cl. G06Q 10/00

(52) U.S. Cl. 705/7

(57) ABSTRACT

A system for interfacing with an information management tool. The system includes a memory for storing information regarding a plurality of programs, each program having at least one capability component. A processor is configured to generate a portfolio of projected capabilities by aggregating the capability components from the plurality of programs, and to create a visualization of each of the projected capabilities at discrete points in time for: analyzing an impact of each projected capability on each of the remaining projected capabilities to identify projected capability implications, and analyzing effects of reallocating resources among the programs to determine changes in the projected capability implications. The system also includes a user interface for displaying projected capability implications due to the effect of reallocating resources.

### CROSS-REFERENCE TO RELATED APPLICATION

This application claims priority to U.S. Provisional Patent Application Ser. No. 61/071,157, filed Apr. 15, 2008, which is incorporated herein by this reference in its entirety.

### BACKGROUND

Over recent years defense (or defence) forces in developed nations have recognized the importance of capability as a planning concept. The motivation for this has been to avoid the problems inherent in focusing solely on equipment platforms to the exclusion of those other capability components (such as training, doctrine, organization etc) that are necessary to deploy military effect. Furthermore, the concept of Through Life Capability Management (TLCM) is emerging as a key approach to planning. Under this concept, a portfolio of capabilities is planned, created, deployed and sustained “from cradle to grave”. However, this approach introduces the challenging problem of choosing a set of investment decisions that will yield a required balance of future capabilities in an environment where the required balance is subject to continual review and change in response to changing circumstances (political, financial, technological). Getting the decision wrong means that the defense force may not be fit for a purpose, or the defense force will have to incur additional cost to acquire additional unplanned capability.

The concept of enterprise architecture (EA)—embodying an integrated collection of diverse information presented through a range of different views to support the interests of diverse communities—has become widely accepted as a basis for business integration and transformation. Within this, a framework such as MODAF (United Kingdom (UK) Ministry of Defence Architecture Framework) have included viewpoints relating to capability and programs to support the application of enterprise architecture (EA) to the modeling of capabilities and their relationships.

Accordingly, it would be desirable to apply the concepts of enterprise architecture to a methodology that creates and uses models of capability to address the problem of identifying and trading between a collection of investment decisions relating to contributing programs (or programmes).

### SUMMARY

An exemplary embodiment is a system for interfacing with an information management tool. The system includes a memory for storing information regarding a plurality of programs, each program having at least one capability component. A processor is configured to generate a portfolio of projected capabilities by aggregating the capability components from the plurality of programs, and to create a visualization of each of the projected capabilities at discrete points in time for: analyzing an impact of each projected capability on each of the remaining projected capabilities to identify projected capability implications, and analyzing effects of reallocating resources among the programs to determine changes in the projected capability implications. The system also includes a user interface for displaying projected capability implications due to the effect of reallocating resources.

An exemplary method is disclosed for a method of analyzing a portfolio of projected capabilities for a system and/or project lifecycle. The method includes creating a portfolio of projected capabilities comprised of a plurality of project components, each of the plurality of project components having a measure of effectiveness, visualizing each of the projected capabilities as a capability target, assembling information relating to a plurality of programs that contribute project components to the portfolio of projected capabilities, generating a campaign plan view of the plurality of programs, and mapping the plurality of programs and the project components to show dependencies between the components.

Another exemplary method is disclosed for a method of exploring trading options. The method includes collecting data from at least one user, wherein the data includes projected capabilities for a plurality of project components, structuring and visualizing the collection of data information, analyzing an impact of each of the projected capabilities on the remaining projected capabilities to identify projected capability implications, and analyzing effects of reallocating resources among the plurality programs to determine changes in the projected capability implications.

An exemplary computer readable medium is disclosed that contains a computer program for analyzing a portfolio of projected capabilities for a system and/or project lifecycle. The computer program comprises executable instructions for: creating a portfolio of projected capabilities comprised of a plurality of project components, each of the plurality of project components having a measure of effectiveness; visualizing each of the projected capabilities as a capability target; assembling information relating to a plurality of programs that contribute project components to the portfolio of projected capabilities; generating a campaign plan view of the plurality of programs; and mapping the plurality of programs and the capability components to show dependencies between the components.

An exemplary computer is disclosed for carrying out steps for analyzing a portfolio of projected capabilities for a system and/or project lifecycle. The steps include: creating a portfolio of projected capabilities comprised of a plurality of project components, each of the plurality of project components having a measure of effectiveness; visualizing each of the projected capabilities as a capability target; assembling information relating to a plurality of programs that contribute project components to the portfolio of projected capabilities; generating a campaign plan view of the plurality of programs; and mapping the plurality of programs and the capability components to show dependencies between the components.

### BRIEF DESCRIPTION OF THE DRAWINGS

In the following, exemplary embodiments will be explained in greater detail in reference to drawings, wherein:

FIG. 1 illustrates a software system for interfacing with an information management tool for visualization of projected capabilities at discrete points in time in accordance with an exemplary embodiment.

FIG. 2 illustrates a graphical user interface having a target view of a higher-level capability (i.e., military task) and a series of target views (or bullseyes) of sub-level capabilities and lower level activities in accordance with an exemplary embodiment.

FIG. 3 illustrates a series of target views (or bullseyes), which graphically display different projected capabilities in accordance with an exemplary embodiment.

FIG. 4 illustrates a linkage of a target view (or bullseye) and a capability staircase view and/or campaign plan in accordance with an exemplary embodiment.

FIG. 5 illustrates a flow diagram depicting a method of analyzing a portfolio of projected capabilities and exploring trading scenarios in accordance with an exemplary embodiment.

FIG. 6 is a flow chart that illustrates a series of steps for collecting and visualizing the required information and/or data for mapping the programming and the capability components to show the full set of dependencies in accordance with an exemplary embodiment.

FIG. 7 is a flow chart that illustrates a series of steps for analyzing the implications of a current program portfolio in terms of projected capability to access the extent to which the projected capability effectiveness is consistent with the projected demand in accordance with an exemplary embodiment.

FIG. 8 is a flow chart that illustrates a series of steps for identify and explore alternative investment options and/or trading scenarios, which correspond to potential changes in the program portfolio in accordance with an exemplary embodiment.

### DETAILED DESCRIPTION

Exemplary embodiments disclosed herein are directed to a computer system and/or software system for interfacing with an information management tool for graphically displaying defense (or defence) capability (or capabilities). In accordance with an exemplary embodiment, defense capability includes a collection of elements that together enable delivery of a set of measurable military effects. For example, such effects might relate to locating or destroying a target, delivering an aid package, or bringing stability to a hostile situation. Furthermore, defense capability typically combines the availability of equipment with a range of other required elements, such as personnel, training, information, doctrine and organization.

In addition, any modern defense force faces the challenge of planning and balancing the set of capabilities that it is able to deploy. Fundamentally, this means making difficult decisions about which acquisition and support programs (or programmes) to fund to what level over time, so as to yield the planned mix of capabilities. Accordingly, it would be desirable to have method and system that provides a platform for the trading between options to achieve a capability mix that gives confidence that the defense force will be able to meet its projected demand.

However, it can be appreciated that this problem is particularly difficult due to the complexities involved including complexity of capabilities and component elements, including the network of inter-relationships between these; and complexity of the portfolio of programs contributing towards capability availability and delivery, including many-to-many relationships between programs and capability components.

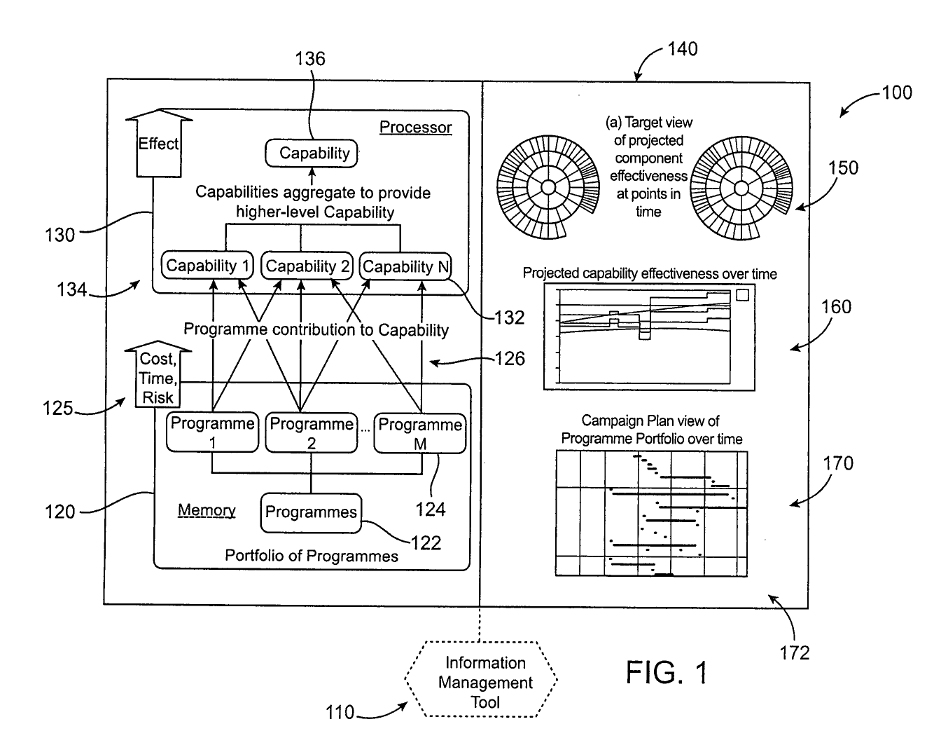

FIG. 1 illustrates an exemplary system 100 for interfacing with an information management tool 110 for visualization of projected capabilities and/or projected capability implications 134 at discrete points in time in accordance with an exemplary embodiment. As shown in FIG. 1, the software system 100 includes a memory 120, a processor 130 and a user interface 140 for displaying projected capabilities and/or projected capability implications 134 due to the effect of reallocating resources.

The memory 120 is configured for storing information regarding a plurality of programs 122, and wherein each program 124 has at least one capability component (or constituent project component) 126. In accordance with an exemplary embodiment, the plurality of programs 122 are a portfolio (or plurality) of programmatic activity, which deliver defense capabilities with a focus on through-life, such that the programmatic effort spans the life cycle of capability components, from conceptual definition and development, through active deployment and decommissioning/termination. In accordance with an exemplary embodiment, the plurality of programs 122 includes the collection and connecting of required information as a basis for analysis and exploration of alternative scenarios and implications to assist defense forces to invest in programmatic activity that can confidently be projected to deliver the required capability mix.

The plurality of programs 122 can be an arrangement of programs 124 within a portfolio, wherein the programs 124 are decomposed into constituent project components and/or capability components 126. Each of the constituent project components or capability components 126 can be aligned with a contribution to capability 132—i.e. the capability components 126 that a project and/or program 124 are responsible for delivering. Also, associated with the portfolio of programs 122 at any time is a cost profile, a delivery schedule over time, and an assessed level of risk 125. It can be appreciated that in accordance with an exemplary embodiment, changing investment decisions moves costs between programs 122 in the portfolio, which alters the balance of capability contribution 126, and alters the effects that will be achievable. This altering of the balance of the capability contribution 126 and the effects that is achievable as set forth herein can be referred to as trading and/or a trading scenario.

In accordance with an exemplary embodiment, a capability (or projected capability) 132 is produced through a combination of a number of different components and/or contributions 126. In accordance with an exemplary embodiment, the software system 100 provides an open approach to enable utilization of disparate sources of data. Information flows through a single information manager (or information management tool) 110, regardless of source/destination, and which is designed to be inclusive, i.e., having the ability to utilize new and extant mechanisms, tools and their providers. The system 100 also includes a graphical user interface 104 with intuitive visualizations, which enables simpler interpretation of results. The system 100 is also capable of incremental and pragmatic development based on user feedback and is scalable to enable aggregation and disaggregation of capability at all levels and providing timeliness and quality with appropriate outputs, which are matched to customer need and decisions.

The processor 130 is configured to generate a portfolio 134 (or plurality) of projected capabilities 132 by aggregating the capability components 126 from each of the plurality of programs 122. The processor 130 also creates a visualization of each of the projected capabilities 132 at discrete points in time. The processor 130 also provides for the ability for a user to analyze the impact of each projected capability 132 on each of the remaining projected capabilities 132 to identify projected capability implications, and analyzing effects of reallocating resources among the programs 124 to determine changes in the projected capability implications. In accordance with an exemplary embodiment, the projected capability implications are based on existing resource allocation, and reallocating resources are analyzed in terms of implications on the projected capabilities 132 over time.

The portfolio 134 of projected capabilities 132 can be an arrangement of defense capabilities, of arbitrary depth, such that any projected capability 132 is provided by a collection of capability components 126 at the next level of abstraction. In accordance with an exemplary embodiment, common capability components 126 can apply to multiple higher-level capabilities 136. In accordance with an exemplary embodiment, the higher-level capability (or higher-level capabilities) 136 are an aggregation of projected capabilities 132. The mix of capabilities 132 within this architecture enables delivery of a specific military “effect”, and by changing the capability architecture, the “effect” also will change.

In accordance with an exemplary embodiment, the information management tool 110 is any commercially available business development and transformation tool suitably programmed in a manner as described herein to generate a desired file in the form of a user interface 140 for the definition and manipulation of the elements and structures described herein. An exemplary information management tool 110 is the Salamander MooD® product. The tool 110 can be used, as disclosed herein to create data structures and data relationships in a processor that encompasses the different visualizations of the projected capabilities 132, 136.

As shown in FIG. 1, the system 100 also includes a user interface 140 for displaying projected capability implications due to the effect of reallocating resources. The user interface 140 can be a display, a graphical user interface, a textual, and/or auditory information, which illustrates projected capabilities 132, 136 at discrete points in time and/or projected capability implications. The projected capabilities 132, 136 and/or projected capability implications can be in the form of a target view (i.e., bullseye) 150, a staircase view 160 and/or a Gantt Chart (i.e., a bar chart that illustrates a project schedule) 170.

As shown in FIG. 1, the projected capabilities 132, 136 and associated level of capability effectiveness over time can be visualised using a target view or target graph panel (TGP) 150 to show the projected capabilities 132, 136 at discrete points in time. In accordance with an exemplary embodiment, the projected effectiveness of each component 126 is according to a color-coded scheme; e.g., Red=component not effective; Orange=component partially effective; and Green=component fully effective. It can be appreciated that the target view (or bullseye) 150 visualisation allows decision makers to assess the acceptability of projected capability 132, 136 at points in time on the basis of effectiveness of specific components 126; e.g., which components are more and/or less important. The target view (or bullseye) 150 is a representation of the standard tree structure hierarchy, wherein the branches of the tree are folded into a circular representation. In accordance with an exemplary embodiment, the basic black and white structure represents the initial definition of the problem in terms of requirement. In addition, different overlays can be created on top of this structure, to represent different views of the projected capabilities 132, 136, which represent comparisons of data and information, including the type of analysis that is represented (the class of overlay) and the rules applied to the overlay to determine the visual effects (e.g. color, shading, size, color combination etc).

In accordance with another exemplary embodiment, the projected capabilities 132, 136 at discrete points in time are graphically displayed by plotting projected capability effectiveness versus time, and wherein the plotting of projected capability effectiveness versus time forms a staircase view 160. In accordance with an exemplary embodiment, the staircase view 160 can be used to show the projected effectiveness over time of a capability 132, 136 against a notional 100% level of effectiveness. It can be appreciated that the staircase view 160 complements the target view 150 by allowing decision makers to assess the acceptability of overall level of effect, including projected peaks and troughs.

In accordance with an exemplary embodiment, the projected capabilities 132, 136 at discrete points in time are graphically displayed by plotting a campaign plan view 172 of the plurality of programs versus time, and wherein the plotting the plurality of programs versus time forms a Gantt Chart 170. The program portfolio over time is visualised using a campaign plan 172, which is a time chart of programs showing milestones and dependencies.

In accordance with an embodiment, the system 100 is provided through a combination of products and services. For example, in accordance with an exemplary embodiment, the information management tool 110 is used as a hub feeding information to and accepting information from the plurality of programs 122 (i.e., analysis tools) available. In accordance with an exemplary embodiment, the information management tool 110 is able to interface with any chosen programs and/or tools. As each action is performed on the data, enhanced information is generated and presented via the information management tool's 110 visualization capabilities to support and facilitate decision making.

It can be appreciated that in accordance with an exemplary embodiment, the system 100 can be tailored to meet the demands of specific customers by adding additional interfaces 140 (i.e., specific tools) and visualization, which can be used to optimize trading performance in individual situations. The system 100 is also available to anyone who has a need to undertake capability trading.

In accordance with an exemplary embodiment, the system 100 as described herein is cyclic in nature. In addition, the amount of time spent in any given area can be dependent on where the customer and/or project are in the overall lifecycle. In an exemplary embodiment, the purveyors of the system 100 and the customer base can be heavily focused on need identification, and problem domain (or problem set) definition, such that little will be done in the later visualizations process step apart from feeding back an abstraction of the problem domain, which can be carried out using one of the inherent visualizations to the customer to seek their endorsement of the system and to maintain joint understanding of the problem.

In using the system 100 in a mature state, a data model will have been constructed and refined over a number of cycles and most of the focus will have shifted from the requirement definition and adapt capture to the value adding a data modeling and manipulation step within the system 100 coupled to the unique visualizations and decision support element of the system 100.

In accordance with an exemplary embodiment, the coupling of 3^{rd} party tools through an information manager or information management tool 110, such as the Salamander® MooD information manager, and then capturing, aggregating and displaying the combined outputs from the data modeling and manipulation activities that identifies the environment that uniquely supports Through Life Capability Management (TLCM).

In an exemplary embodiment, the application of visualization tools such as the bullseye 150 can be linked to the capability staircase model, based on the same data capture, which illustrates the utility of intuitive visualizations providing unique views into the data for specific target audiences. For example, the target view or bullseye 150 visualizations provide the ability to overlay additional attributes (such as priority and/or importance, cost, performance, industrial capacity, contribution), and then by way of a further overlay perform a gap analysis or a time based maturation analysis using several target or bullseye views 150. In addition, the ability to visualize multiple element attributes on top of the basic taxonomy for the customer area, which allows the system 100 to uniquely inform or assist with the decision making process.

In accordance with another exemplary embodiment, the campaign plan 160 visualization is a static program management view allowing representation of timeline information, while having the ability to overlay addition attributes through use of colors and/or shapes. In accordance with another exemplary embodiment, the campaign plan 160 can be used in option identification and trading activities by making it dynamic in nature.

In accordance with a further exemplary embodiment, the system artifact links the dynamic campaign plan 160 to visualization of maturity of a chosen information manager or management tool 110 element attribute over time, (i.e., a dynamic Gantt chart 170). The dynamic Gantt chart 170 when read from left to right is similar to the campaign plan. When the dynamic Gantt 170 chart is read from top to bottom it shows the relationship (curve) between the campaign plan elements and the maturation of a specific measurement of interest, capability value or specific performance characteristic. The shape and structure of this curve then reflects the changes in time of the contributing components, their values etc. and offers opportunities to investigate why such a particular shape exists or such a trend in the delivery against the required measure.

In accordance with another exemplary embodiment, data capture can include identifying what the customer needs to do, identifying the data set that already exists to help model the problem domain, collecting and collating the data, which can include identifying inconsistencies with the already existing data and using suitable engagement methods such as individual interviews or group workshops remove the data inconsistencies, and identifying gaps in the already existing data set and using suitable engagement methods such as engaging with adjacent departments having either direct or indirect interfaces with the area under consideration or further discussions within the domain area (using suitable engagement methods such as individual interviews or group workshops) and seeking additional sources to fill gaps in the data set. The data capture can also include controlling the data using the information manager to create a “single source of truth”, identifying through customer engagement and using the captured data, the taxonomy applicable to the customers domain including the use of a target graph panel (TGP) or bullseye 150, and based on this agreed taxonomy, identifying such things as the priority for elements, the current status of the element maturity, or risk levels associated with the elements, which can be displayed on the base taxonomy as overlays.

In a further exemplary embodiment, data modeling and manipulation can be performed by identifying the system solution appropriate for the particular domain considering the agreed definition of the problem, wherein the solution in this context means to identify those 3^{rd} party tools that could be used to explore the problem domain to help inform the customer. For example, some of the problem domains can include: where the toolsets already ‘deployed’ and having known interfaces to the core information manager or management tool 110 can be used to support the customer need; where supporting a particular customer has identified an area that is not currently support by an already identified toolset; or wherein this toolset might already have an interface with the information manager but has yet to be deployed in which case deployment of the toolset will be through a known and documented process. In accordance with an exemplary embodiment, a toolset must first be identified and then the interface trialed and then robustly deployed to support the particular customer. Following this initial deployment, the system partners must decide if this new toolset interface should be provided for others or will it remain unique to only one customer. If it is unique then no further action will be taken. However, if it is believed that the identified tool could be applied to new or previous solution, then the interface is industrialized between the tool vendor and the information management tool 110 owner, which can then be applied in a similar manner as outlined above to develop a new solution. In accordance with a further exemplary embodiment, the solution can be offered to previous customers to enhance their data analysis portfolio on an as required basis. In all of the above examples, it is through understanding of the problem domain and working with the customer base to manipulate already existing data or helping derive and capture new data and then being able to provide intuitive visualizations targeted at different levels in the customer area but all using the same core data set that are the strengths of the system's environment and underpin the premise that information management is core to Through Life Capability Management (TLCM).

In accordance with an exemplary embodiment, since the information management tool 110 can provide a large number of visualizations inherent in the design, a number of specific visualizations have been developed that have proved useful in information visualization for capability decision making and trading. For example, providing new and/or addition views of data that is already exist can add insight through data aggregation, overlays and analysis that support the customers understanding of his domain. The visualizations then allow the making of better informed decisions. The use of customer judgment combined with the additional perspectives of existing information allows them to reinforce or discount decision options (articulated in the system as capability trading). In an exemplary embodiment, each of the views is based on a single version of the truth, which also supports the system's 100 principle of evidenced information for informed decision making.

In accordance with an exemplary embodiment, a target graph panel 150 (TGP) can be used. As described herein, the target graph panel 150 is a visualization of a hierarchy starting from a central theme and working outwards. In its basic form (black and white), the target graph panel 150 is purely an intuitive representation of the hierarchy. In the system 100 as described herein, the target graph panel 150 has the ability to both capture and then overlay additional attributes onto the hierarchy that is the unique value added that the methodology provides.

In accordance with another exemplary embodiment, a campaign plan 160 (TGSP) is a view of information based on time, events, comprising tasks and milestones and dependencies between these. The system 100 as described herein brings a unique ability to group the information elements shown on the campaign plan 160 by anything the elements are related to within the information manager or management tool 110, directly or indirectly. Another unique ability of the campaign plan 160 is to show information element attributes visually by color or shape. Again, these element attributes can be inherited directly or indirectly.

In accordance with a further exemplary embodiment, a dynamic Gantt chart 170 (DGC) is a combined view bringing together information represented in a dynamic campaign plan and allowing visualization of the maturation of a specific measurement of interest, capability value or specific performance characteristic. The dynamic Gantt chart 170 is a visualization of the impact of change, which allows adjustment to be made against a set of constraints as captured during the data capture process step. Using a Gantt chart 170, the system 100 as described herein provides the customer with the ability to dynamically visualize the impact of change of an element on the campaign plan 160 (over time) on the specific measurement of interest, capability value or specific performance characteristic in a trading environment to provide immediate feedback as to the implications of change (i.e., support to the change management process).

In accordance with another exemplary embodiment, a metamodel can be used. A metamodel is an enhanced and extended MODAF (United Kingdom Ministry of Defence Architectural Framework) framework. The metamodel provides the basis for structuring the data and thus facilitating gap analysis and production of the unique artifacts and insights into the customer problem. The metamodel also provides consistency of the data structure allowing aggregation and disaggregation of data at different hierarchical levels.

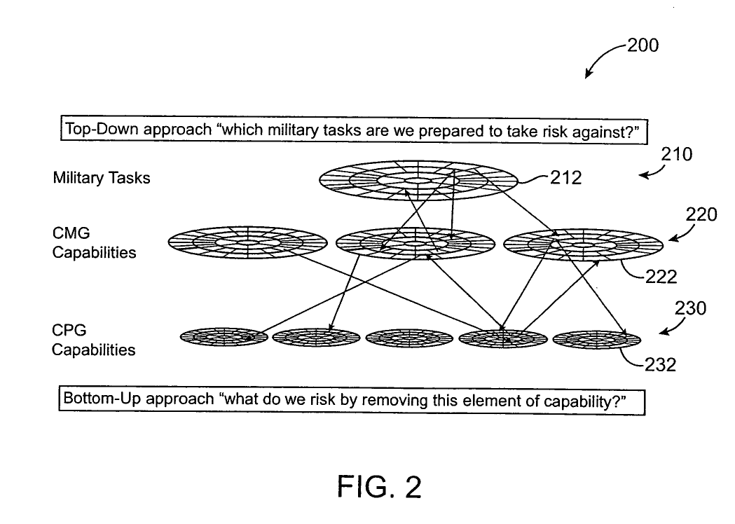

FIG. 2 illustrates a graphical user interface 200 having a target view 210 of a higher-level capability 212 (i.e., military task) and a series or plurality of sub-target views 220 of sub-level capabilities 222 and a series or plurality of target views 230 pertaining to lower level activities 232 in accordance with an exemplary embodiment. As shown in FIG. 2, the target views 210, 220, 230 depict how the projected capabilities 212, 222, 232 are nested and linked to one another, such that a higher level capability 212 expressed in output terms (e.g. Military Tasks) can be linked through a plurality of sub-level capabilities 222 (e.g. CMG capabilities) to a plurality of lower level activities in a capability space 232 (e.g. CPG capabilities).

In accordance with an exemplary embodiment, different overlays (not shown) can be placed on top of the target view 210 and sub-target views 220, 230 to represent different views of the projected capabilities 212, 222, 232, and which represent a comparison of data and information. For example, overlays can be used to show the importance of each contribution, solution artefacts, requirements for future procurements and/or aspirations to capability, time and/or trend comparisons, project activities, maturity (industry and/or military), scenario prioritisations, and risk and/or mitigation.

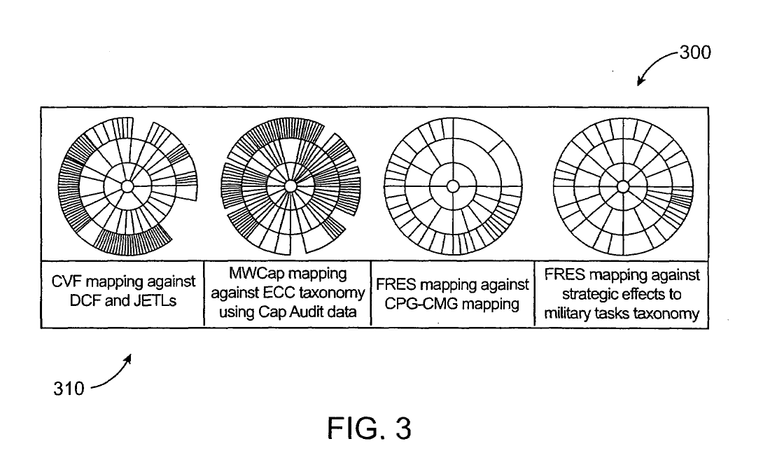

FIG. 3 illustrates a series of target views (or bullseyes) 300, which graphically display different projected capabilities 310 in accordance with an exemplary embodiment. As shown in FIG. 3, a series or plurality of target views 300 can be used to provide the ability to aggregate and combine the contributions to the different projected capabilities 310, which can include distinct classes such as capability (both military and industrial), cost (i.e., component pieces), maturity, and trends.

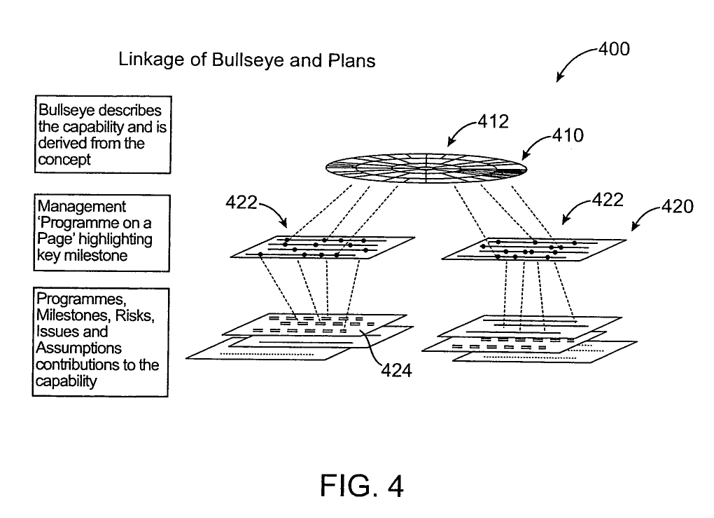

FIG. 4 illustrates a linkage 400 of a target view (or bullseye) 410 and a capability staircase view and/or a campaign plan 420 in accordance with an exemplary embodiment. As shown in FIG. 4, the target views (or bullseyes) 410 describe the projected capabilities 412. In accordance with an embodiment, the capability staircase view and/or campaign plan 420 can be used to highlight key milestones 422, and further show programs, milestones, risks, issues, and assumptions contributing to the evolution of the projected capability and/or projected capabilities 424.

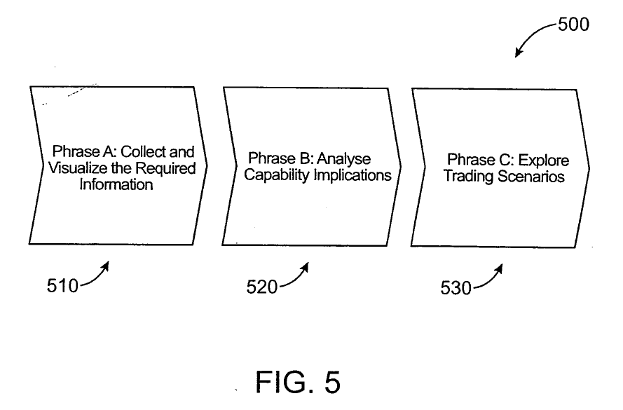

FIG. 5 illustrates a flow diagram depicting a method 500 of analyzing a portfolio of projected capabilities and exploring trading scenarios in accordance with an exemplary embodiment. As shown in FIG. 5, the method 500 performs the step 510 of collecting data from at least one user, wherein the data includes projected capabilities for a plurality of capability components and structuring and visualizing the collection of data information including defense capabilities and their components. In step 520, the projected capability implications over time are analyzed using a plurality of contributing programs and mapping the projected capability implications to one another, and wherein the projected capability implications are contingent on existing investment decisions. In step 530, the method then explores trading scenarios whereby alternative investment options are analyzed in terms of their implications on the projected capability mix over time, as a basis for decisions on trading investments across the plurality of programs.

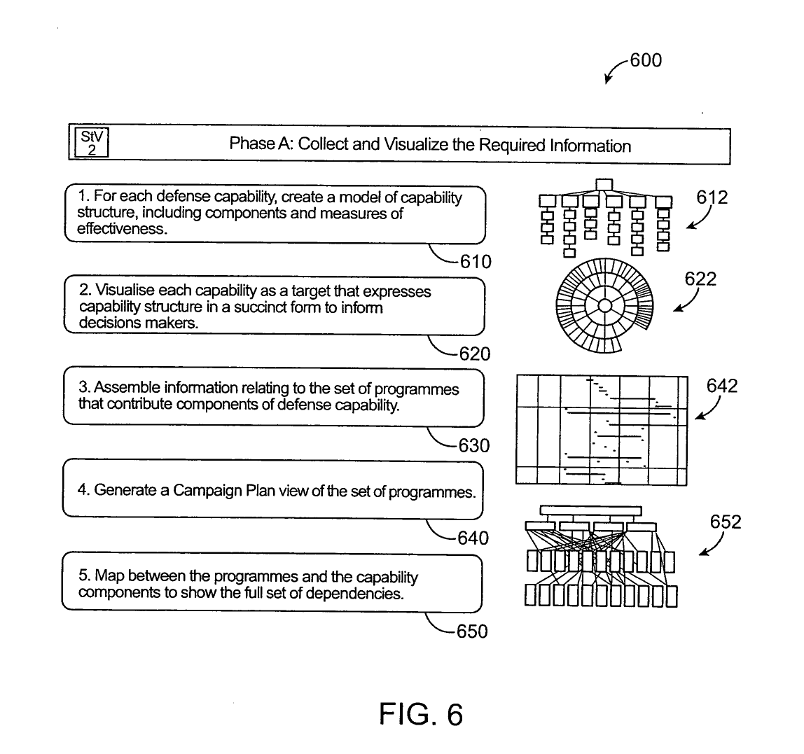

FIG. 6 is a flow chart that illustrates a series of steps 600 for collecting and visualizing the required information and/or data for mapping the programming and the capability components to show the full set of dependencies in accordance with an exemplary embodiment. The first phase (Phase A) of the methodology comprises five steps 610, 620, 630, 640, 650 that together collect and/or gather, structure and visualizes the information needed to execute the analysis of projected capability implications (Phase B) and the exploration of trading scenarios (Phase C).

As shown in FIG. 6, in step 610, the system collects and visualizes the required information for each defense capability, and creates a model of capability or projected capability structure 612, including component components and measures of effectiveness. In step 620, each of these capabilities and/or projected capabilities are then visualized in the form of a target or target view 622 (i.e., bullseye) that expresses capability structure in a succinct form to inform decision makers. In steps 630, 640, information relating to the set of programs that contribute components of defense capability is assembled and a campaign plan view 642 of the set of programs is generated. In step 650, the programs and the capability components are then mapped 652 to show the full set of dependencies.

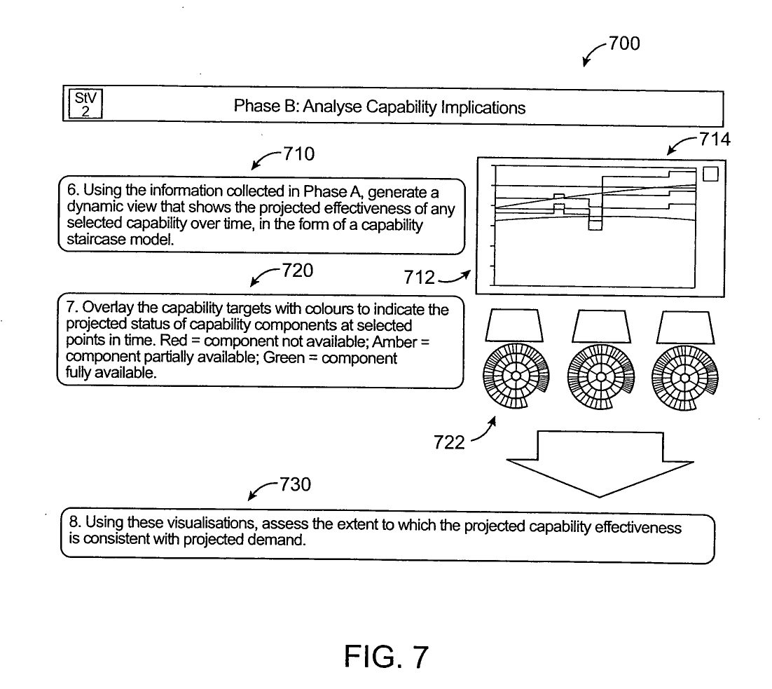

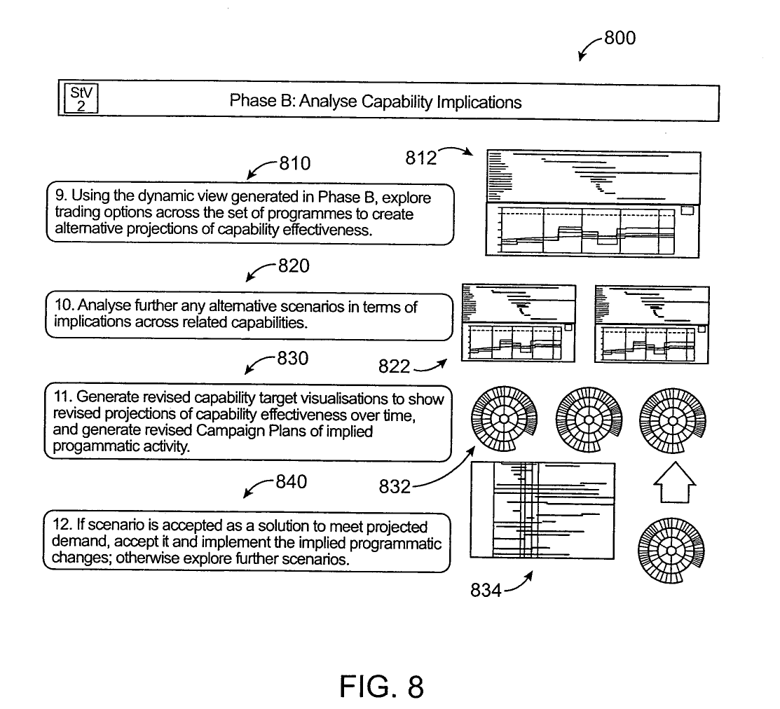

FIG. 7 is a flow chart that illustrates a series of steps 700 for analyzing the implications of a current program portfolio in terms of projected capability to access the extent to which the projected capability effectiveness is consistent with the projected demand in accordance with an exemplary embodiment. As shown in FIG. 7, the second phase (Phase B) of the method comprises three steps 710, 720, 730 that together analyze the implications of the current program portfolio in terms of projected future capability. In accordance with an exemplary embodiment, if these implications are acceptable, and funding is in place to continue the planned investment, then the method terminates. (i.e., step 730). If this is not the case, then the last phase (Phase C) (FIG. 8) of the method is executed to explore alternatives.

As shown in FIG. 7, in step 710, the system analyzes capability implications by using the information collected in the first phase (Phase A), generating a dynamic view 712 that shows the projected effectiveness of any selected capabilities over time, in the form of a capability staircase model 714. In step 720, the capability targets 722 are then overlaid with colors to indicate the projected status of capability components at selected points in time. In accordance with an exemplary embodiment, colors can indicate, for example, Red=component not available; Yellow=component partially available; Green=component fully available. In step 730, these visualizations are then used to assess the extent to which the projected capability effectiveness is consistent with projected demand.

FIG. 8 is a flow chart that illustrates a series of steps 800 for identifying and exploring alternative investment options and/or trading scenarios, which correspond to potential changes in the program portfolio in accordance with an exemplary embodiment. In step 810, using the dynamic view 812 generated in the second phase (Phase B), trading options across the set of programs are explored to create alternative projections of capability effectiveness. In step 820, any alternative scenario (dynamic views 822) is analyzed in terms of implications across related capabilities. In step 830, revised capability target visualizations 832 are generated to show revised projections of capability effectiveness over time, and revised campaign plans 834 of implied programmatic activity are generated. In step 840, if a scenario is accepted as a solution to meet projected demand, the scenario is accepted and the implied programmatic changes are implemented. Alternatively, further scenarios are then explored. The steps can be repeated until a satisfactory solution is identified.

In an exemplary embodiment, a computer program which implements all or parts of the processing described herein through the use of a system and/or methodology as illustrated in FIGS. 1-8 can take the form of a computer program product residing on a computer usable or computer readable medium. Such a computer program can be an entire application to perform all of the tasks necessary to carry out the processes and/or methodologies, or it can be a macro or plug-in which works with an existing general-purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What is claimed is:

1. A system for interfacing with an information management tool, the system comprising:
a memory for storing information regarding a plurality of programs, each program having at least one capability component;
a processor configured to generate a portfolio of projected capabilities by aggregating the capability components from the plurality of programs, and to create a visualization of the projected capabilities at discrete points in time for:
analyzing an impact of the projected capability on the remaining projected capabilities to identify projected capability implications; and
analyzing effects of reallocating resources among the programs to determine changes in the projected capability implications; and
a user interface for displaying projected capability implications due to the effect of reallocating resources.

2. The system of claim 1, wherein the user interface is a graphical user interface.

3. The system of claim 1, wherein the projected capabilities at discrete points in time are displayed by placing hierarchical data in a circular format starting from a higher-level capability and working outward to a series of descending sub-level capabilities, which forms a target view.

4. The system of claim 3, comprising:
graphically displaying the higher-level capability target views in a series of target views comprised of data for sub-level capabilities and lower level activities.

5. The system of claim 1, wherein the projected capabilities at discrete points in time are graphically displayed by plotting projected capability effectiveness versus time.

6. The system of claim 1, wherein the projected capabilities at discrete points in time are graphically displayed by plotting a campaign plan view of the plurality of programs versus time.

7. The system of claim 3, wherein the target view has a color-coded scheme for graphically displaying the effectiveness of each capability component.

8. The system of claim 1, wherein each of the plurality of programs decompose into constituent projects, and wherein each of the constituent projects is aligned with at least one contribution to the portfolio of projected capabilities.

9. The system of claim 1, wherein each of the plurality of programs at any time has a cost profile, a delivery schedule and an assessed level of risk.

10. The system of claim 1, wherein the portfolio of projected capabilities is comprised of a collection of components that together enable delivery of a set of measurable military effects.

11. The system of claim 1, wherein the projected capability implications are based on existing resource allocation.

12. The system of claim 1, wherein reallocating resources are analyzed in terms of implications on the projected capabilities over time.

13. A method of analyzing a portfolio of projected capabilities for a system and/or project lifecycle, the method comprising:
creating a portfolio of projected capabilities comprised of a plurality of project components, each of the plurality of project components having a measure of effectiveness;
visualizing each of the projected capabilities as a capability target;
assembling information relating to a plurality of programs that contribute project components to the portfolio of projected capabilities;
generating a campaign plan view of the plurality of programs; and
mapping the plurality of programs and the project components to show dependencies between the project components.

14. The method of claim 13, wherein the portfolio of projected capabilities is comprised of a plurality of programs, each program having at least one project component, and aggregating the project components from each of the plurality of programs.

15. The method of claim 13, comprising:
generating a capability staircase model, which shows the projected effectiveness of any selected capability over time;
overlaying the capability targets with colors to indicate the projected status of capability components at selected points in time; and
using the capability staircase model and the capability targets with colors to visualize and assess the extent to which the projected capability effectiveness is consistent with projected demand.

16. The method of claim 13, comprising:
analyzing an impact of each projected capability on each of the remaining projected capabilities to identify projected capability implications; and
analyzing effects of reallocating resources among the programs to determine changes in the projected capability implications by:
creating alternative projections of capability effectiveness by using the capability staircase model and the capability targets to explore trading options across the plurality of programs;
analyzing further alternative scenarios in terms of implications across related capabilities;
generating revised capability target visualizations to show revised projections of capability effectiveness over time; and
generating revised campaign plans of implied programmatic activity.

17. The method of claim 16, wherein if a scenario is accepted as a solution to meet projected demand, the scenario is accepted, and the implied programmatic activity is implemented.

18. The method of claim 13, wherein the system and/or project lifecycle spans the life cycle of capability components, from conceptual definition and development, through active deployment and decommissioning and/or termination.

19. The method of claim 13, wherein the capability targets show at discrete points in time the projected effectiveness of each component according to a color-coding scheme.

20. The method of claim 13, wherein the visualization allows decision makers to assess the acceptability of projected capability at points in time based on effectiveness of specific components.

21. The method of claim 13, comprising:
a staircase view, which shows the projected effectiveness over time of a capability against a notional level of effectiveness.

22. The method of claim 13, wherein each of the plurality of programs are decomposed into constituent projects, and wherein each of the constituent projects can be aligned with a contribution to capability.

23. The method of claim 13, wherein the plurality of programs at any time include a cost profile, a delivery schedule over time, and an assessed level of risk.

24. A method of exploring trading options, the method comprising:
collecting data from at least one user, wherein the data includes projected capabilities for a plurality of project components;
structuring and visualizing the collection of data information;
analyzing an impact of each of the projected capabilities on the remaining projected capabilities to identify projected capability implications; and
analyzing effects of reallocating resources among the plurality programs to determine changes in the projected capability implications.

25. The method of claim 24, wherein collecting data from at least one user further comprises polling the at least one user to determine needs of the at least one user to support delivery of the projected capabilities.

26. The method of claim 24, wherein the projected capabilities are a collection of components that together enable delivery of a set of measurable military effects.

27. A computer readable medium containing a computer program for analyzing a portfolio of projected capabilities for a system and/or lifecycle, wherein the computer program comprises executable instructions for:
creating a portfolio of projected capabilities comprised of a plurality of project components, each of the plurality of project components having a measure of effectiveness;
visualizing each of the projected capabilities as a capability target;
assembling information relating to a plurality of programs that contribute project components to the portfolio of projected capabilities;
generating a campaign plan view of the plurality of programs; and
mapping the plurality of programs and the project components to show dependencies between the components.

28. The computer readable medium of claim 27, wherein the portfolio of projected capabilities is comprised of a plurality of programs, each program having at least one project component, and aggregating the project components from each of the plurality of programs.

29. The computer readable medium of claim 27, comprising:
generating a capability staircase model, which shows the projected effectiveness of any selected capability over time;
overlaying the capability targets with colors to indicate the projected status of project components at selected points in time; and
using the capability staircase model and the capability targets with colors to visualize and assess the extent to which the projected capability effectiveness is consistent with projected demand.

30. The computer readable medium of claim 27, comprising:
analyzing an impact of each projected capability on each of the remaining projected capabilities to identify projected capability implications; and
analyzing effects of reallocating resources among the programs to determine changes in the projected capability implications by:
creating alternative projections of capability effectiveness by using the capability staircase model and the capability targets to explore trading options across the plurality of programs;
analyzing further alternative scenarios in terms of implications across related capabilities;
generating revised capability target visualizations to show revised projections of capability effectiveness over time; and
generating revised campaign plans of implied programmatic activity.

31. A computer configured to carry out steps for analyzing a portfolio of projected capabilities for a system and/or lifecycle, the steps comprising:
creating a portfolio of projected capabilities comprised of a plurality of project components, each of the plurality of project components having a measure of effectiveness;
visualizing each of the projected capabilities as a capability target;
assembling information relating to a plurality of programs that contribute project components to the portfolio of projected capabilities;
generating a campaign plan view of the plurality of programs; and
mapping the plurality of programs and the capability components to show dependencies between the components.

32. The computer of claim 31, wherein the portfolio of projected capabilities is comprised of a plurality of programs, each program having at least one project component, and aggregating the project components from each of the plurality of programs.

33. The computer of claim 31, comprising:
generating a capability staircase model, which shows the projected effectiveness of any selected capability over time;
overlaying the capability targets with colors to indicate the projected status of project components at selected points in time; and
using the capability staircase model and the capability targets with colors to visualize and assess the extent to which the projected capability effectiveness is consistent with projected demand.

34. The computer of claim 31, comprising:
analyzing an impact of each projected capability on each of the remaining projected capabilities to identify projected capability implications; and
analyzing effects of reallocating resources among the programs to determine changes in the projected capability implications by:
creating alternative projections of capability effectiveness by using the capability staircase model and the capability targets to explore trading options across the plurality of programs;
analyzing further alternative scenarios in terms of implications across related capabilities;
generating revised capability target visualizations to show revised projections of capability effectiveness over time; and
generating revised campaign plans of implied programmatic activity.
